(19) United States
(12) Patent Application Publication
(10) Pub. No.: US 2006/0043300 A1
(43) Pub. Date: Mar. 2, 2006

(54) Water activity determination using near-infrared spectroscopy

(75) Inventors: Nigel H. Campbell, Pullman, WA (US); Gaylon S. Campbell, Pullman, WA (US); Scott H. Campbell, Sewickley, PA (US); Anthony J. Fontana JR., Pullman, WA (US); Richard M. Ozanich, Richland, WA (US)

Correspondence Address: HOLLAND & HART LLP, 60 E. SOUTH TEMPLE, SUITE 2000, SALT LAKE CITY, UT, 84111, US

(73) Assignee: Decagon Devices, Inc.

(21) Appl. No.: 10/932,379

(22) Filed: Sep. 2, 2004

(51) Int. Cl. G01N 21/35

(52) U.S. Cl. 250/339.09

(57) ABSTRACT

A method and apparatus for determining water activity levels of samples by spectral analysis. The method and apparatus facilitate much faster water activity level measurement than prior methods and apparatus. The method may include calibrating a spectral analyzer by correlating samples of known water activity to certain spectral features. A calibrated apparatus according to principles of the present invention may very quickly correlate spectral features of a sample of interest with a water activity level to a high degree of accuracy.

### FIELD OF THE INVENTION

This invention relates generally to methods and devices for characterizing the state of water in a material, and more particularly to methods and devices for measuring water activity in a material.

### BACKGROUND OF THE INVENTION

Two moisture measurements are required to completely characterize the state of water in a material such as a food product sample. The first measurement is water content. Water content is a measure of the amount of water in the sample. Water content can be directly determined by drying a sample, for example, in an oven at a specified temperature, and measuring the water lost per unit mass of the original sample. The second measurement required to characterize the state of water is the water activity, usually represented as a_{w}.

Water activity measurements can serve several useful purposes. Water activity may be measured in plants, soils, and foods, as well as other product samples. Most commonly, water activity is measured with respect to food products. Water activity or water potential is measured in food products to determine or predict food stability with respect to physical properties, rates of deteriorative reactions, and microbial growth. Water activity is a primary factor that determines shelf life of food products. Several other factors, such as temperature and pH along with water activity, can influence whether organisms will grow in food products, as well as the rate at which such organisms will grow. Nonetheless, water activity may be the most important factor in determining whether organisms will grow in food products.

Water activity is indicative of the energy required to remove a small amount of water from the sample. Water activity is represented as a ratio between the vapor pressure of the sample itself, when in a completely undisturbed balance with the surrounding air media, and the vapor pressure of distilled water under identical conditions. A water activity measurement of 0.80 means that the vapor pressure of the sample is eighty percent of the vapor pressure of pure water at the same conditions. Water activity is typically measured by equilibrating a small sample of a product in a sealed container and determining the relative humidity of a headspace. If the sample and the headspace are in thermal and vapor equilibrium, the humidity of the headspace is equal to the water activity of the sample. Knowledge of water activity is critical in determining the safety of a variety of shelf-stable foods. If a product has a water activity greater than or equal to approximately 0.85, it will support the growth of food pathogenic bacteria, regardless of the water content of the product.

Although the water content and water activity of certain foods and other products is critical, the standard methods for measuring both water content and water activity can be time consuming, and are not well suited to on-line monitoring. Oven drying typically takes between eight to twenty-four hours, and water activity measurements usually take between five and thirty minutes. As a result of the traditionally long length of time required to make these measurements, particularly for water content, new methods have been introduced for measuring water activity.

One relatively new method developed by Decagon Devices for measuring water activity involves the absorption or reflection of near infrared radiation. Liquid water reflects radiation at a wavelength region centered at approximately 960 nm within a scan spectrum of 900-1700 nm. The more water contained by the sample, the stronger the reflection band becomes. It is therefore possible to correlate the strength of the radiation band with the water activity of a sample, and to use measurements on this band to infer water content of similar samples of unknown water content. Measuring water activity based on infrared radiation absorption or reflection is nearly instantaneous, drastically increasing the measurement speed of water activity and water content over traditional methods.

However, measuring water activity is not available instantaneously according to any traditional methods. Traditional techniques for measuring water activity may be categorized into one of five general methods: hair or polymer hygrometers, freezing point depression, isopiestic equilibration, electric hygrometers, and chilled mirror dew point sensors.

Hair or polymer hygrometers operate according to the principle that hair and polymer (e.g. polyamide thread) length changes predictably with humidity. Therefore, hair or polymer is connected to a recorder pen or a dial that reads directly in percent relative humidity. Hair or polymer hydrometers are relative simple to use and generally provide accuracy on the order of ±0.03 to 0.05 a_{w}. However, hair or polymer hydrometers are slow to reach equilibrium, exhibit non-linear behavior at humidity extremes, are affected by commonly used volatiles (e.g. alcohol), and tend to exhibit hysteresis.

Freezing point depression determines water activity levels by measuring the depression in freezing point relative to pure water as follows:

$${a}_{w} = \frac{{p}_{ice}}{{p}_{supercooledwater}}$$

Freezing point depression meters are simple to use, very precise, and are not affected by volatiles. However, they have a limited range of use (a_{w}<0.90), take only very small sample sizes, required extrapolation of water activity to room temperature values, and are very difficult to perform on non-solution based samples.

In the isopiestic method, the water activity of foods is determined through equilibrium sorption. Isopiestic equilibration methods measure water activity by equilibrating a sample with a reference material in a vacuum desiccator for twenty-four to forty-eight hours, determining a sorption isotherm curve for the reference material (usually microcrystalline cellulose), determining moisture content for the reference material, and correlating the moisture content to a water activity by reference to the isotherm curve. Isopiestic equilibration is highly accurate at high water activity levels and simple to use, but it takes at least twenty-four hours to reach equilibrium.

Electric hygrometers determine water activity based on the principle that the hygroscopic material within the sensor changes its electrical properties with relative humidity. There are generally two types of electric hygrometers: resistance-based and capacitance-based. Electric hygrometers are generally accurate to ±0.01 a_{w} and capable of the full range of water activity levels, but they also take time reach equilibrium, need a secondary method of calibration, generally exhibit some sensor hysteresis, and need to be compensated for temperature.

As the name implies, chilled mirror dew point methods determines the dew point temperature by cooling a mirror surface until dew is formed. The temperature at which saturation is achieved is determined by observing condensation on the mirror. This method is highly accurate (generally to ±0.003 a_{w}), a primary method of measuring vapor pressure, and can usually be accomplished in about five minutes. The method requires a very clean mirror, however, and readings can be affected by alcohol and propylene glycol.

The method described above is capable of measuring water activity in slightly less than five minutes, and most take considerably more time. Therefore, there remains a need for determining water activity in products and samples at faster speeds than traditionally available.

### SUMMARY OF THE INVENTION

In one of many possible embodiments, the present invention provides a method of determining water activity of a sample. The method comprises correlating an electromagnetic spectrum of the sample to a point on a water activity calibration curve. The method may further include differentiating the electromagnetic spectrum of the sample before correlating it to a point on the water activity calibration curve to eliminate baseline shifts. The correlating may include applying chemometric analysis to the electromagnetic spectrum of the sample and matching chemometric data to the point on the water activity calibration curve. According to some embodiments, correlating further comprises observing wavelength peak shifts and changes in wavelength peak width, and matching spectral features observed with the point on the water activity calibration curve.

The water activity calibration curve may be created by: (a) generating an electromagnetic spectrum for a material, (b) analyzing the electromagnetic spectrum with chemometrics software, (c) measuring the water activity of the material with a water activity meter, (d) assigning spectral features determined by the chemometrics software to the water activity of the material, and

repeating steps (a)-(d) for a plurality of samples of the material at different water activity levels. Those of skill in the art will understand that the order of the steps (a)-(d) is not limited to the order presented, the steps may be accomplished in other orders. For example, step (c) may be done first, and step (a) may be done second.

The water activity calibration curve may also be created by: (a) generating an electromagnetic spectrum for a material, (b) analyzing the electromagnetic spectrum for peak wavelengths, (c) analyzing a width of a curve at the peak wavelengths, (d) measuring the water activity of the material with a water activity meter, (e) correlating the peak wavelengths and the widths thereof to the measured water activity, and repeating steps (a)-(e) for a plurality of samples of the material at different water activity levels. Again, as with all of the methods disclosed herein, the order steps are accomplished is not limited by the presentation order. According to some methods of generating the calibration curve, the electromagnetic spectrum may be differentiated and analyzed for zeros and slope data. Further, according to some methods wavelength bands above approximately 1700 nm are eliminated or filtered from the spectrum.

Methods of determining water activity according to the principles described herein facilitate the water activity measurement of the sample in less than three minutes. In fact the water activity of the sample may be determined in less than five seconds according to some methods described herein.

Another aspect of the invention provides a method of determining water activity of a sample, comprising correlating positions of wavelength peaks of an electromagnetic spectrum of the sample to a water activity calibration curve. The calibration curve may be created by: (a) generating an electromagnetic spectrum for a material, (b) analyzing the electromagnetic spectrum for peak wavelengths, (c) measuring the water activity of the material with a water activity meter, (d) correlating the peak wavelengths and the widths thereof to the measured water activity; and repeating steps (a)-(d) for a plurality of samples of the material at different water activity levels. The method may include differentiating the electromagnetic spectrum and analyzing the differentiated spectrum for zeros.

Another method of the invention provides a method of determining water activity of a sample, comprising correlating changes in wavelength peak width of an electromagnetic spectrum of the sample to a water activity calibration curve. The water activity calibration curve may be created by: (a) generating an electromagnetic spectrum for a material, (b) analyzing the electromagnetic spectrum for peak wavelength curves, (c) analyzing width of the peak wavelength curves, (c) measuring the water activity of the material with a water activity meter, (d) correlating the width of the peak wave curves to the measured water activity, and (e) repeating steps (a)-(d) for a plurality of samples of the material at different water activity levels.

Another aspect of the invention provides a method of determining water activity a material, comprising: (a) generating an electromagnetic spectrum for a sample of the material, (b) analyzing the electromagnetic spectrum for peak wavelengths, (c) analyzing a width of the peak wavelengths, (d) measuring the water activity of the sample with a water activity meter, (e) correlating the peak wavelengths and the widths thereof to the measured water activity, (f) repeating steps (a)-(e) for a plurality of samples of the material at different water activity levels to build a calibration curve, (g) generating an electromagnetic spectrum for a sample of interest of the material, and (h) correlating the electromagnetic spectrum for the sample of interest with a water activity based on the calibration curve. This method may include rotating the sample through a light source.

Another aspect of the invention provides a method of calibrating an NIR water activity meter comprising: (a) generating an electromagnetic spectrum for a sample of the material, (b) analyzing the electromagnetic spectrum with chemometrics software to generate spectral data, (c) measuring the water activity of the sample with a water activity meter, (d) correlating the spectral data to the measured water activity, and repeating steps (a)-(d) for a plurality of samples of the material at different water activity levels.

Another aspect provides a method of measuring water activity of a material, comprising shining a light source on the material, generating a reflectance or absorbance spectrum, analyzing the reflectance or absorbance spectrum with a spectrometer, and calculating water activity of the material based on the reflectance or absorbance spectrum. The method may include filtering out wavelengths of the reflectance or absorbance spectrum over approximately 1700 nm.

Another aspect provides a method of measuring water activity of a sample of a material, comprising correlating chemometric analysis of spectral data of the sample with known water activity data of the material. According to this method, the correlating may include comparing the spectral data of the sample with spectral data of other samples having known water activity.

Another aspect of the invention provides a water activity measurement apparatus, comprising: a light source, a sample holder, a fiber optic cable adjacent to the sample holder, a spectrometer connected to the spectrum collecting cable, a computer operatively connected to the spectrometer, the computer comprising access to instructions that, when executed, correlate spectral features from the spectrometer with a water activity level. The spectrometer may be an NIR analyzer having chemometric analysis capability. The sample holder may comprise a rotating plate or disc according to some embodiments. According to some embodiments the sample holder comprises: a housing in which the light source is contained, the housing having a first transparent window, a rotating plate having a second transparent window adjacent to the housing, a drive motor for turning the rotating plate disposed within the housing, wherein the second transparent window of the rotating plate is alignable with the first transparent window of the housing. The second transparent window may be a hole receptive of a sample dish.

Another aspect of the invention provides a sample holding apparatus, comprising: a housing having a first optically transparent portion, a rotary table having a second optically transparent portion receptive of a sample, a motor for rotating the rotary table, a light source disposed inside the housing, and a spectrum collecting cable disposed inside the housing and contiguous with the optically transparent portion. The motor may include a motor axle extending through the housing and contacting an edge of the rotary table and at least two guide rollers attached to the housing and contacting the edge of the rotary table. The rotary table may include a circular disc, and the second optically transparent portion of the rotary table be an eccentric hole.

Another aspect of the invention provides a method of determining water activity of a sample comprising: generating an electromagnetic spectrum of the sample, differentiating the spectrum, analyzing the differentiated spectrum for slope and zeros, correlating the slope and zeros to a water activity level.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is an electromagnetic spectrum generated by a spectrometer for a certain material sample according to one embodiment of the present invention.

FIG. 2 is a graph illustrating a correlation between wave peak location and water activity for numerous samples of a material according to one embodiment of the present invention.

FIG. 3 is a partial electromagnetic reflectance spectrum centered around approximately 825 nm for several samples of a product material according to one embodiment of the present invention.

FIG. 4 is a graph illustrating a correlation between wave peak width and water activity for numerous samples of a material according to one embodiment of the present invention.

FIG. 5 is an enlarged view of the partial electromagnetic reflectance spectrum of FIG. 3, illustrating the spectrum in the 900-1000 nm wavelength range.

FIG. 6 is a first derivative of the partial electromagnetic reflectance spectrum of FIG. 5.

FIG. 7 is a perspective view of a water activity measurement apparatus according to one embodiment of the present invention, including a sample holder, a spectrometer, and a computer.

FIG. 8A is an enlarged perspective view of the sample holder shown in FIG. 7 without a plate.

FIG. 8B is an enlarged perspective view of the sample holder shown in FIG. 7 with the sample plate but without a sample dish.

FIG. 9 is a perspective view of another water activity measurement apparatus according to one embodiment of the present invention, including a sample holder with an overhead illumination source, a spectrometer, and a computer.

Throughout the drawings, identical reference numbers designate similar, but not necessarily identical, elements.

### DETAILED DESCRIPTION

The present invention provides methods and apparatus for quickly and accurately determining water activity. As mentioned above, water activity is an important parameter for many products, particularly food products. Measuring water activity with typical water activity meters requires somewhere between five minutes and two days, which can be a significant problem, for example, for food processors operating assembly lines. The present invention enables water activity determination much faster than conventional methods. According to principles described herein, water activity may be determined in approximately five seconds or less. Unlike any conventional methods, the present invention contemplates analysis of electromagnetic spectral features of material samples to measure water activity using, for example, near-infrared (“NIR”) spectroscopy. According to the present invention, spectra of samples of known water activity level are analyzed and/or manipulated to generate a water activity calibration curve or equation. Consequently, the water activity calibration curve may be reverse-correlated with spectral features of an unknown sample to determine the water activity level of the unknown sample very quickly.

As used throughout the claims and specification, the term “water activity meter” refers to apparatus capable of measuring water activity directly and includes apparatus and methods in the five categories discussed above in the background. The word “plate” refers to any device capable of holding a material sample, including a disc. The term “align” or “alignable” means that one item or feature is capable of being arranged at least partly contiguous with another. “Contiguous” means within a common boundary (e.g. Utah is contiguous with the United States). A “table” is an item with length or width dimensions significantly greater than a thickness dimension. The words “including” and “having,” as used in the specification, including the claims, have the same meaning as the word “comprising.”

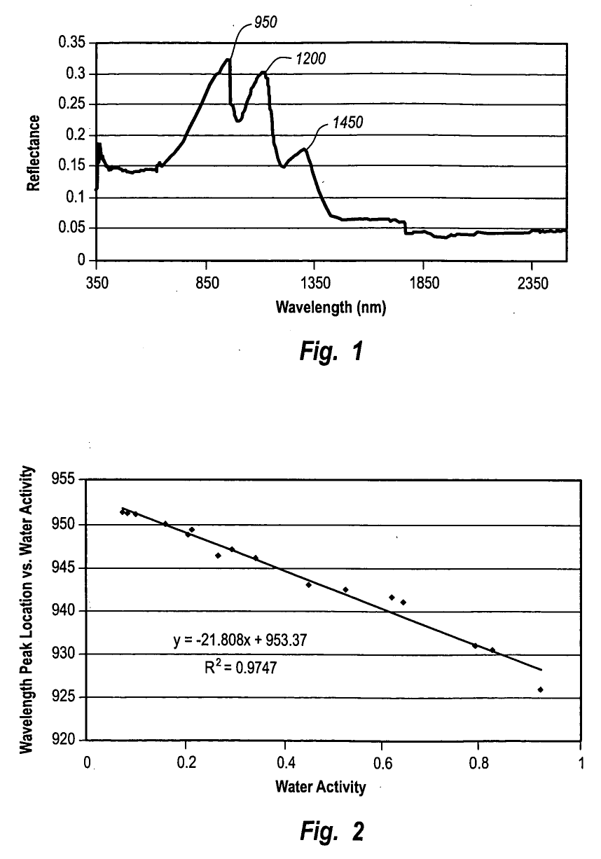

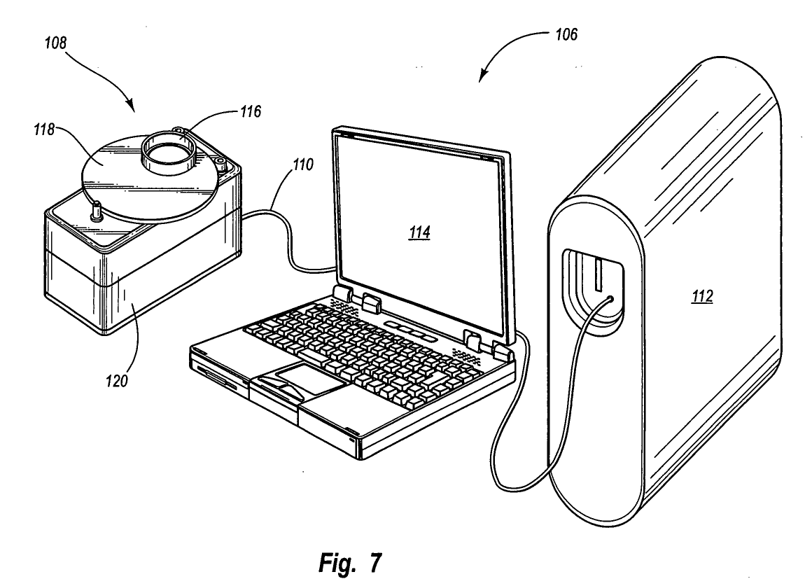

Turning now to the drawings, and in particular FIG. 1, an electromagnetic reflectance spectrum for a material sample is shown. The electromagnetic reflectance spectrum may be generated by a spectrometer, for example an NIR spectrometer available from Analytical Spectral Devices® as shown below with reference to FIG. 7. The major reflectance bands for water are generally located at wavelengths between 850 and 2000 nm. There are usually four major reflectance bands for water located between 850 and 2000 nm. The wavelength centers of the four major water reflectance bands are typically centered near 950, 1200, 1450, and 1900 nm. The present inventors discovered that the wavelength centers of one or more of the four major water reflection bands may be used according to principles of the present invention to determine water activity of a sample. According to some aspects of the present invention, an electromagnetic spectrum for a material sample (such as the reflectance spectrum shown in FIG. 1) is correlated to a water activity measurement and reported to a user. As described in more detail below, the reflectance spectrum of a sample of interest is compared to a calibration curve, equation, or database of spectral data representative of reflectance spectrums of samples having known water activity levels. A water activity level is then calculated or matched to the reflectance spectrum of the sample of interest based on the comparison of the reflectance spectrum of the sample of interest with the spectral data of samples of known water activity level. However, according to some embodiments, spectral features at an upper range of the electromagnetic spectrum (1800- 2500 nm) may be eliminated or filtered out, including the reflection band centered near 1900 nm. Due to current spectral detector designs and limitations, significant expense can be reduced by eliminating the upper range of the electromagnetic spectrum without significantly reducing the accuracy of water activity determination.

The principles of the present invention facilitate measurement of water activity by correlating spectral features of various materials with a water activity. FIG. 2 illustrates one example of one correlation between spectral features of a sample and water activity. As mentioned above, one of the wavelength centers of the four major water reflectance is typically centered near 950 nm. As shown in FIG. 2, wavelength peak location (centered near 950 nm) is plotted against water activity. FIG. 2 shows a very strong correlation between shifts in the wavelength peak location (according to the present figure for bands near 950 nm) and water activity. FIG. 2 is created by generating a reflectance spectrum for several samples of the same material at varying water activity levels. The water activity level may be measured, for example, by an AquaLab® water activity meter before or after generating the reflectance spectrum. Many samples of various water activity levels were used to create the plot of FIG. 2 to illustrate the strong correlation between spectral features of a material and water activity.

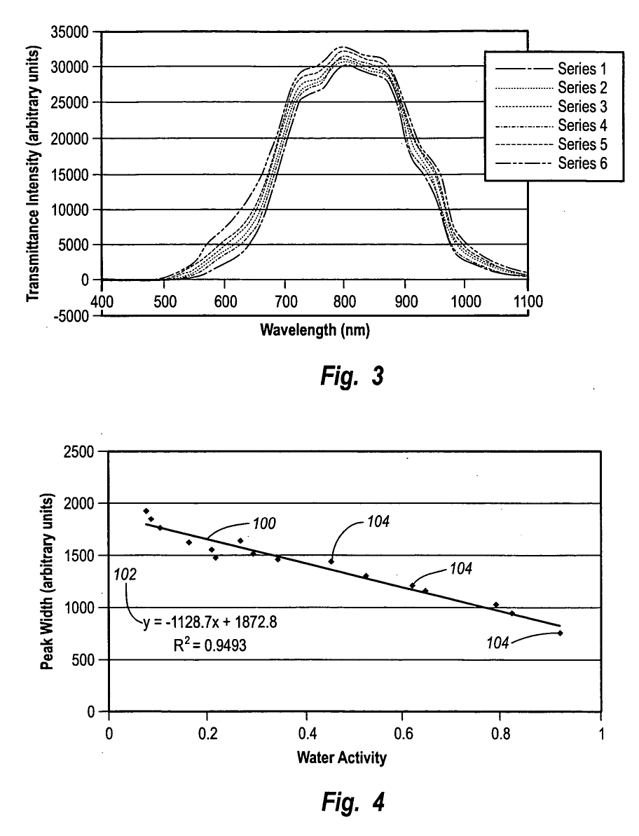

Other spectral features in addition to or alternative to shifts in wavelength peak location may also be correlated to water activity level. For example, FIG. 3 illustrates a series of reflectance spectra for a certain material at different water activity levels on a single chart. As shown in FIG. 3, different water activity levels of the material tend to change the width of wavelength peaks. According to principles of the present invention, width changes at wavelength peak locations may be analyzed and correlated to water activity levels. Similar to FIG. 2, FIG. 4 shows a very strong correlation between wavelength peak width (according to FIG. 4 for bands near 950 nm) and water activity. As with FIG. 2, FIG. 4 may be created by generating a reflectance spectrum for several samples of the same material at varying water activity levels. The water activity level may be measured by a water activity meter and a plot is created. Many widely available software programs may be programmed according to principles of the present invention to generate a correlation or calibration curve 100 and associated equation 102 based on the individual data points 104. The equation 102 has spectral data as the independent variable, and water activity as the dependent variable. Therefore, once the equation 102 or calibration curve 100 is generated using spectral data and known water activity levels, water activity of unknown samples may be measured by providing spectral data for the unknown sample to the equation. The calibration curve 100 or equation 102 may also be replaced by a database of spectral data and associated water activity levels. Programming may interpolate between or extrapolate beyond spectral data in the database and assign water activity levels to samples of unknown water activity level based on spectral data input of an unknown sample.

Therefore, according to principles of the present invention, correlations between spectral features of a material and water activity are measured and recorded to generate a water activity calibration curve, equation, or database. The calibration curve, equation, or database is then used to determine water activity for unknown samples based on spectral features of the unknown samples. However, different materials tend to have different calibration curves, equations, or data sets. Therefore, according to principles of the present invention, an individual material or group of materials may each comprise a different calibration curve, equation, or set of database data. Two or more spectral features may also be combined to create a more accurate calibration curve or database. For example, both wavelength peak location and wavelength peak width may be taken into account to generate a calibration curve, equation, or database based on known water activity values. In addition, it will be understood that spectral data from more than a single peak location may be used. The illustration of FIGS. 3-4 showing just one peak is exemplary in nature and used to illustrate the principles of the present invention. According to some embodiments, two, three, or more wavelength peaks are analyzed first for calibration purposes, and later for reverse-correlation water activity measurement purposes.

According to some aspects of the present invention, in order to even further increase the accuracy of a calibration curve and eliminate baseline shifts, instead of directly using spectral data such as that shown in FIG. 3 to generate a calibration curve, equation, or database, the spectral data is first mathematically manipulated. For example, according to some aspects, spectra are differentiated prior to generating a calibration curve, equation, or database. Wavelength peak height and area are related to the amount of water (water content) in a sample, and therefore by differentiating, water activity is measured, rather than water content. Spectra of samples of unknown water activity levels are also differentiated and correlated to differentiated spectra of known water activity. Further, water activity is a function of temperature, and therefore shining a light on a sample to generate an electromagnetic spectrum may cause variation in the predicted water activity due to the temperature variation. Using a derivative of spectra, measured samples only varied between 0.001 and 0.003 a_{w} per degree C. This variation is consistent with typical water activity changes of 0.002a_{w} per degree C using the best conventional methods.

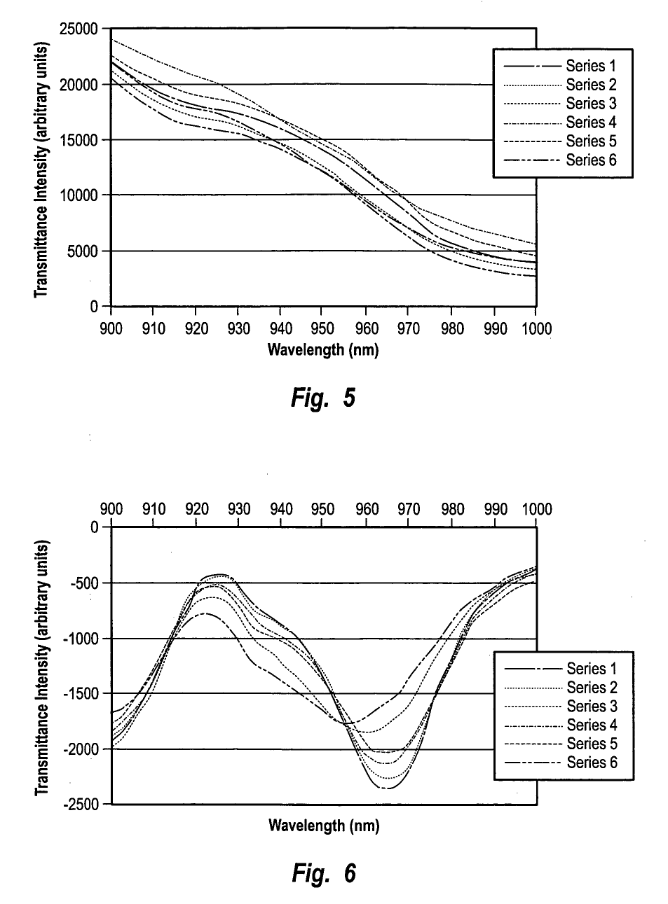

FIG. 5 illustrates an enlarged portion of the spectra shown in FIG. 3 between the wavelengths of 900 and 1000 nm. A first derivative of the portion of the spectra shown in FIG. 5 is illustrated in FIG. 6. Using the first derivative of the spectra shown in FIG. 5, the curves of FIG. 6 may be analyzed for zeros, which would represent peak locations. The first derivative curves may also be analyzed for slope values, which are indicative of wavelength peak width, or for other features. The derivative of the spectra allows for easy identification of spectral features of interest, while also eliminating unnecessary data and baseline shifts.

Therefore, according to principles of the present invention, water activity of a sample of interest may be determined by correlating an electromagnetic spectrum or a derivative of the spectrum of the sample of interest to a point on a calibration curve, a value from a calibration equation, or to data in a database. The calibration curve, equation, or database is built by generating electromagnetic spectra for calibration samples of material comprising the same or similar material as the sample of interest, analyzing the spectra, measuring the water activity of each of the calibration samples with a water activity meter, and assigning spectral features of the calibration samples to the measured water activity data. The water activity level of the calibration samples may be measured before or after the generation of an electromagnetic spectrum for each. Further, as discussed above, the spectra for the calibration samples may also be differentiated before assigning spectral features to measured water activity data.

Accordingly, while it may take considerable time to generate calibration curves, equations, or databases for one or more different types of material, once the calibration curves, equations, or databases have been created, water activity levels of unknown samples of interest can be nearly instantaneously measured. Samples of interest may be illuminated with a light source, and standard spectrometers typically generate a spectrum of the sample of interest in less than five seconds. Spectral analysis software may be programmed according to principles described herein to correlate the spectrum of the sample of interest with a water activity level based on the calibration curve, equations, or database previously generated. It will be understood by skilled artisans having the benefit of this disclosure that the same or similar procedures can be applied to both reflectance and absorbance spectra.

Although water activity can be determined according to the principles described above by monitoring and analyzing shifts in wavelength peaks and/or changes in wavelength peak width, other spectral features may also be used to enhance the accuracy of water activity measurement by spectral analysis. For example, instead of monitoring changes to only one or two spectral features (e.g. wavelength peak location and width), a chemometric approach may be used to compare spectral features of different product samples. Chemometric approaches generally use most or all of the spectral data available from a sample spectrum. Chemometrics is a statistical approach to spectral analysis that allows specific spectral features, and their changes, to be correlated with changes in concentration of sample constituents. Standard chemometrics software available with Analytical Spectral Devices®'s spectrometer, may therefore be programmed according to principles of the present invention to correlate spectral features of unknown samples with spectral features of calibration samples of known water activity level.

The methods of determining water activity using NIR spectroscopy as described above may be accomplished with many different apparatus. For example, according to one embodiment of the present invention shown in FIG. 7, a water activity measurement apparatus 106 includes a sample holder 108, a spectrum collecting cable such as a fiber optic cable 110 adjacent to and extending into the sample holder 108, a spectrometer such as an Analytical Spectral Devices® NIR analyzer 112 connected to the fiber optic cable 110, and a computer 114 operatively connected to the NIR analyzer 112. The computer 114 or NIR analyzer 112 includes or has access to instructions that, when executed, correlate spectral features from the spectrometer with a water activity level. The instructions may comprise the methods described above for generating and analyzing an electromagnetic spectrum, and then correlating an unknown sample spectrum with previous spectra of known water activity level (e.g. a calibration curve, equation, or database). The computer 114 may also include instructions that, when executed, create calibration data by generating, analyzing, and storing spectra of various samples, and allowing the input of known or measured water activity data corresponding to each of the various samples. The methods of calibrating may include calibrating for many different materials or material types, and therefore the instructions may prompt a user for a material or material type. The NIR analyzer 112 and/or computer 114 may include chemometric analysis capability whereby chemometric calibration data corresponding to known water activity levels is correlated to chemometric data for an unknown sample.

The sample holder 108 is shown in FIG. 7 with a sample dish 116 set on or in a rotating table or plate, for example a disc 118. The sample dish 116 is preferably sealed to allow the sample to remain constant during the water activity measurement process. Exposing the sample to environmental conditions (room humidity) may result in the sample absorbing or desorbing water and changing water activity.

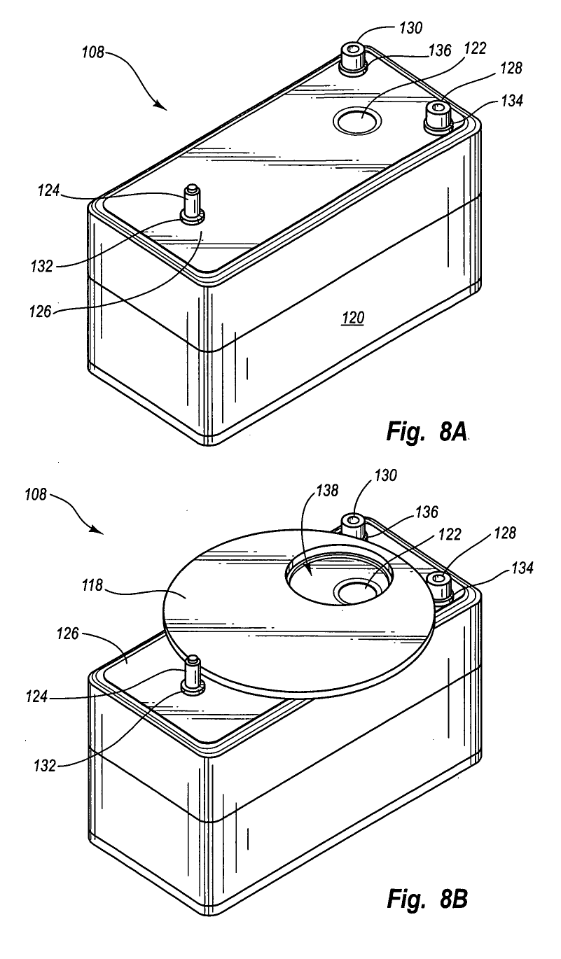

The sample holder 108 is shown in FIG. 8A without the sample dish 116 (FIG. 7) or the rotating disc 118 (FIG. 7) to show certain features of the sample holder 108. As shown in FIG. 8A, the sample holder 108 includes a housing 120 in which a light source is contained. The housing 120 is generally rectangular or cubic. The housing 120 has a first transparent window 122 that may comprise an open aperture or a piece of transparent material such as glass. The first transparent window 122 is contiguous with an end of the fiber optic cable 110 (FIG. 7), which is adapted to receive spectral data. The housing 120 also partially covers a drive motor comprising a drive axle 124. The drive axle 124 extends through the housing 120. As shown in FIG. 8A, the drive axle 124 is not centered within a first or top surface 126 of the housing, but it could be. The drive axle 124 includes a first step 132 adjacent to the top surface 126. At least two guide rollers 128, 130 are rotatably attached to the top surface 126 of the housing and spaced approximately equidistant from the drive axle 124. The guide rollers 128, 130 are freely rotatable and comprise second and third ledges or steps 134, 136, respectively, adjacent to the top surface 126.

Referring next to FIG. 8B, the rotating disc 118 is shown sitting on or above the top surface 126. According to the embodiment shown, the rotating disc 118 is spaced above the top surface 126 by resting the rotating disc 118 on the ledges or steps 132, 134, 136 of the drive axle 124 and guide rollers 128, 130, respectively. The drive axle 124 thus contacts or engages the rotating disc 118, and, in combination with the guide rollers 128, 130, positions the rotating disc 118 over the top surface 126.

As shown in FIG. 8B, the rotating disc 118 includes a second transparent window 138, which, similar to the first transparent window 122, may comprise an open, eccentric hole as shown or a piece of transparent material. The second transparent window 138 is at least partially alignable with the first transparent window, “alignable” meaning that a straight line perpendicular to the top surface 126 may pass through both the first and second transparent windows 122, 138 in at least one position. According to the embodiment of FIG. 8B, the first transparent window 122 is contiguous with the second transparent window 138 when the first and second transparent windows 122, 138 are aligned. The second transparent window 138 is receptive of the sample dish 116 shown in FIG. 7.

In order to generate repeatable spectra, sample homogeneity can be important. Typical spectral devices illuminate a sample from above to generate an electromagnetic spectrum. For samples of uniform height, an overhead light source is usually sufficient. However, for samples of various height, (e.g. flour, raisins), the variable distances between the sample and the spectrum collection cable can reduce repeatability. In addition, slight variations in the sample itself can decrease accuracy and repeatability. Accordingly, the sample holder 108 of the present invention rotates a sample across a larger area of the sample than previous spectral sample holding apparatus, and illuminates from below the sample where distances between the end of the fiber optic cable 110 (FIG. 7) and the sample contained by the sample dish 116 (FIG. 7) are constant. Illumination from below the sample and rotation of the sample provides for more accurate, repeatable spectra and therefore more accurate NIR water activity measurements. The sample holder 108 may also be used for other uses and is not limited to NIR water activity measurement.

Although the housing 120 shown in FIGS. 8A-8B is shown with the drive axle 124 substantially tangent to the rotating disc 118, according to alternative embodiments there are no guide rollers 128, 130 and the drive axle is attached at a center of the rotating disc 118.

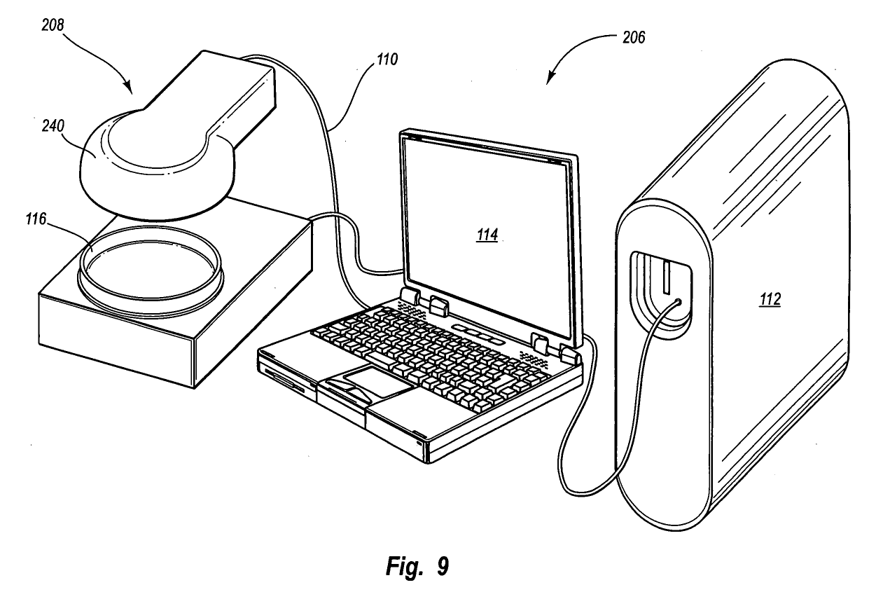

Another embodiment of an NIR water activity measurement apparatus 206 is shown in FIG. 9. The NIR water activity measurement apparatus 206 includes a sample holder 208, the fiber optic cable 110 adjacent to the sample holder 208, the Analytical Spectral Devices® NIR analyzer 112 connected to the fiber optic cable 110, and the computer 114 operatively connected to the NIR analyzer 112. The computer 114 or NIR analyzer 112 also includes or has access to instructions that, when executed, correlate spectral features from the spectrometer with a water activity level as discussed above. However, unlike the sample holder 108 of FIG. 7, the sample holder 208 of FIG. 9 includes an overhead light source 240 and the sample dish 116 does rotate. The sample holder 208 may provide sufficiently accurate water activity measurements for samples that are generally uniform in height, such as liquid products. Other sample holders may also be used according to principles of the present invention to measure water activity levels based on spectral data.

The preceding description has been presented only to illustrate and describe exemplary embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of determining water activity of a sample, comprising correlating an electromagnetic spectrum of the sample to a point on a water activity calibration curve.

2. A method of determining water activity of a sample according to claim 1, further comprising differentiating the electromagnetic spectrum of the sample before correlating it to a point on the water activity calibration curve.

3. A method of determining water activity of a sample according to claim 1 wherein the correlating further comprises applying chemometric analysis to the electromagnetic spectrum of the sample and matching chemometric data to the point on the water activity calibration curve.

4. A method of determining water activity of a sample according to claim 1 wherein the correlating further comprises observing wavelength peak shifts and changes in wavelength peak width and matching spectral features observed with the point on the water activity calibration curve.

5. A method of determining water activity of a sample according to claim 1, further comprising creating the water activity calibration curve by:
(a) generating an electromagnetic spectrum for a material;
(b) analyzing the electromagnetic spectrum with chemometrics software;
(c) measuring the water activity of the material with a water activity meter;
(d) assigning spectral features determined by the chemometrics software to the water activity of the material;
(e) repeating steps (a)-(d) for a plurality of samples of the material at different water activity levels.

6. A method of determining water activity of a sample according to claim 1, further comprising creating the water activity calibration curve by:
(a) generating an electromagnetic spectrum for a material;
(b) analyzing the electromagnetic spectrum for peak wavelengths;
(c) analyzing a width of a curve at the peak wavelengths;
(d) measuring the water activity of the material with a water activity meter;
(e) correlating the peak wavelengths and the widths thereof to the measured water activity;
(f) repeating steps (a)-(e) for a plurality of samples of the material at different water activity levels.

7. A method of determining water activity of a sample according to claim 1, further comprising creating the water activity calibration curve by:
(a) generating an electromagnetic spectrum for a material;
(b) differentiating the electromagnetic spectrum;
(c) analyzing the differentiated electromagnetic spectrum for zeros;
(d) analyzing the differentiated electromagnetic spectrum for slope data;
(e) measuring the water activity of the material with a water activity meter;
(f) correlating the position of the zeros and the slope data with the measured water activity;
(g) repeating steps (a)-(f) for a plurality of samples of the material at different water activity levels to build the calibration curve.

8. A method of determining water activity of a sample according to claim 7 wherein the generating comprises eliminating wavelength bands above approximately 1700 nm.

9. A method of determining water activity of a sample according to claim 1 wherein the water activity of the sample is determined in less than three minutes.

10. A method of determining water activity of a sample according to claim 1 wherein the water activity of the sample is determined in less than five seconds.

11. A method of determining water activity of a sample, comprising correlating positions of wavelength peaks of an electromagnetic spectrum of the sample to a water activity calibration curve.

12. A method of determining water activity of a sample according to claim 11 wherein the water activity calibration curve is created by:
(a) generating an electromagnetic spectrum for a material;
(b) analyzing the electromagnetic spectrum for peak wavelengths;
(c) measuring the water activity of the material with a water activity meter;
(d) correlating the peak wavelengths to the measured water activity;
(e) repeating steps (a)-(d) for a plurality of samples of the material at different water activity levels.

13. A method of determining water activity of a sample according to claim 11 wherein the water activity calibration curve is created by:
(a) generating an electromagnetic spectrum for a material;
(b) differentiating the electromagnetic spectrum;
(c) analyzing the differentiated electromagnetic spectrum for zeros;
(d) measuring the water activity of the material with a water activity meter;
(e) correlating the position of the zeros with the measured water activity;
(f) repeating steps (a)-(d) for a plurality of samples of the material at different water activity levels.

14. A method of determining water activity of a sample according to claim 11, further comprising correlating a width of the wavelength peaks of the electromagnetic spectrum of the sample to the water activity calibration curve.

15. A method of determining water activity of a sample, comprising correlating changes in wavelength peak width of an electromagnetic spectrum of the sample to a water activity calibration curve.

16. A method of determining water activity of a sample according to claim 15 wherein the water activity calibration curve is created by:
(a) generating an electromagnetic spectrum for a material;
(b) analyzing the electromagnetic spectrum for peak wavelength curves;
(c) analyzing width of the peak wavelength curves;
(c) measuring the water activity of the material with a water activity meter;
(d) correlating the width of the peak wave curves to the measured water activity;
(e) repeating steps (a)-(d) for a plurality of samples of the material at different water activity levels.

17. A method of determining water activity of a sample according to claim 15, further comprising correlating a position of wavelength peaks of the electromagnetic spectrum of the sample to the water activity calibration curve.

18. A method of determining water activity for a sample of interest of a material, comprising:
(a) generating an electromagnetic spectrum for a specimen of the material;
(b) analyzing the electromagnetic spectrum for peak wavelengths;
(c) analyzing a width of the peak wavelengths;
(d) measuring the water activity of the sample of the material with a water activity meter;
(e) correlating the peak wavelengths and the widths thereof to the measured water activity;
(f) repeating steps (a)-(e) for a plurality of specimen of the material at different water activity levels to build a database of spectral data and correlated water activity levels;
(g) generating an electromagnetic spectrum for the sample of interest of the material;
(h) correlating the electromagnetic spectrum for the sample of interest with a water activity based on the database of spectral data.

19. A method of determining water activity of a material according to claim 18, further comprising rotating the sample of interest through a light source.

20. A method of determining water activity of a material according to claim 18 wherein the analyzing the electromagnetic spectrum for peak wavelength and widths comprises analysis by chemometrics software.

21. A method of determining water activity a material according to claim 18 wherein the analyzing of steps (b) and (c) further comprises eliminating baseline shifts.

22. A method of determining water activity a material according to claim 18 wherein the analyzing of steps (b) and (c) further comprises eliminating baseline shifts by differentiating the electromagnetic spectrum.

23. A method of calibrating an NIR water activity measurement apparatus comprising:
(a) generating an electromagnetic spectrum for a sample of the material;
(b) analyzing the electromagnetic spectrum with chemometrics software to generate spectral data;
(c) measuring the water activity of the sample with a water activity meter;
(d) correlating the spectral data to the measured water activity;
(e) repeating steps (a)-(d) for a plurality of samples of the material at different water activity levels.

24. A method of determining water activity, comprising:
(a) shining a light source on a sample of a material;
(b) analyzing an electromagnetic spectrum of the sample with a spectrometer;
(c) measuring a water activity level of the sample with a water activity meter;
(d) correlating the electromagnetic spectrum with the measured water activity;
(e) repeating steps (a)-(d) for a plurality of samples of the material at different water activity levels to generate a calibration equation;
(f) generating an electromagnetic spectrum for a sample of interest of the material;
(g) correlating the electromagnetic spectrum for the sample of interest with a water activity based on the calibration equation.

25. A method of determining water activity according to claim 24, wherein the analyzing further comprises differentiating the electromagnetic spectrum to eliminate base line shifts.

26. A method of determining water activity according to claim 24 wherein the sample and the sample of interest are rotated through the light source.

27. A method of measuring water activity of a material, comprising:
shining a light source on the material;
generating an electromagnetic spectrum;
analyzing the electromagnetic spectrum with a spectrometer;
calculating water activity of the material based on the electromagnetic spectrum.

28. A method of measuring water activity of a material according to claim 27, further comprising calibrating the spectrometer based on known water activity levels for various samples of the material.

29. A method of measuring water activity of a material according to claim 27, further comprising placing the material on a sample holder and rotating the sample holder through the light source.

30. A method of measuring water activity of a material according to claim 27, further comprising filtering out wavelengths of the electromagnetic spectrum over approximately 1800 nm.

31. A method of measuring water activity of a sample of a material, comprising correlating chemometric analysis of spectral data of the sample with known water activity data of the material.

32. A method of measuring water activity of a sample of a material according to claim 31 wherein the correlating comprises comparing the spectral data of the sample with spectral data of other samples having known water activity.

33. A method of measuring water activity of a sample of a material according to claim 31 wherein the known water activity data is generated by:
(a) measuring a water activity level of a material specimen with a water activity meter;
(b) shining a light source on the material specimen;
(c) analyzing a reflectance or absorbance spectrum data of the material specimen with a spectrometer;
(d) assigning the reflectance or absorbance spectrum data to the measured water activity level;
(e) repeating steps (a)-(d) for a plurality of specimens of the material at different water activity levels.

34. A method of determining water activity of a product, comprising:
(a) generating an electromagnetic spectrum for a sample of the product;
(b) analyzing the electromagnetic spectrum with chemometrics software;
(c) measuring the water activity of the sample with a water activity meter;
(d) correlating spectral features determined by the chemometrics software with the water activity of the sample;
(e) repeating steps (a)-(d) for a plurality of samples of the product at different water activity levels;
(h) generating an electromagnetic spectrum for a sample of interest of the product;
(i) reverse correlating the electromagnetic spectrum for the sample of interest to a water activity.

35. A method of determining water activity of a product according to claim 34 wherein the analyzing further comprises:
differentiating the electromagnetic spectrum;
examining the differentiated electromagnetic spectrum for zero values;
examining the differentiated electromagnetic spectrum for slope values; and wherein the correlating further comprises:
associating a position of the zero values and the slope values with the measured water activity.

36. A water activity measurement apparatus, comprising:
a light source;
a sample holder;
a spectrum collecting cable adjacent to the sample holder;
a spectrometer connected to the spectrum collecting cable;
a computer operatively connected to the spectrometer, the computer comprising access to instructions that, when executed, correlate spectral features from the spectrometer with a water activity level.

37. A water activity measurement apparatus according to claim 36 wherein the spectrometer comprises an NIR analyzer having chemometric analysis capability.

38. A water activity measurement apparatus according to claim 36 wherein the sample holder comprises a rotating plate.

39. A water activity measurement apparatus according to claim 36 wherein the sample holder comprises:
a housing in which the light source is contained, the housing having a first transparent window;
a rotating plate having a second transparent window adjacent to the housing;
a drive motor for turning the rotating plate disposed within the housing;
wherein the second transparent window of the rotating plate is alignable with the first transparent window of the housing.

40. A water activity measurement apparatus according to claim 39 wherein the second transparent window comprises a hole receptive of a sample dish.

41. A water activity measurement apparatus according to claim 36 wherein the sample holder comprises:
a housing in which the light source is contained, the housing having a first transparent window;
a rotating plate with a transparent portion adjacent to the housing;
a drive motor disposed within the housing having a drive axle extending through the housing;
at least two guide rollers contacting a circumferential edge of the rotating plate;
wherein the drive axle contacts a circumferential edge of the rotating plate.

42. A water activity measurement apparatus according to claim 36 wherein the sample holder comprises:
a housing in which the light source is contained, the housing having a top surface and a first transparent window disposed in the top surface;
a drive motor disposed within the housing having a drive axle extending through the housing, the drive axle comprising a step adjacent to the top surface;
a pair of guide rollers attached normal to the top surface, each of the pair of guide rollers comprising a step adjacent to the top surface;
a disc disposed between and contacting the drive axle and the pair of guide rollers, the disc resting on the steps of the drive axle and the pair of guide rollers, the disc comprising a second transparent window alignable with the first transparent window.

43. A water activity measurement apparatus according to claim 36 wherein the spectrum collecting cable comprises a fiber optic line contiguous with a first transparent window disposed in the sample holder.

44. A sample holding apparatus, comprising:
a housing having a first optically transparent portion;
a rotary table having a second optically transparent portion receptive of a sample;
a motor for rotating the rotary table;
a light source disposed inside the housing;
a spectrum collecting cable disposed inside the housing and contiguous with the optically transparent portion.

45. The sample holding apparatus of claim 44, further comprising:
a motor axle extending through the housing and contacting an edge of the rotary table;
at least two guide rollers attached to the housing and contacting the edge of the rotary table.

46. The sample holding apparatus of claim 44 wherein the rotary table comprises a circular disc, and the second optically transparent portion of the rotary table comprises an eccentric hole.

47. A method of determining water activity of a sample comprising:
generating an electromagnetic spectrum of the sample;
differentiating the spectrum;
analyzing the differentiated spectrum for slope and zeros;
correlating the slope and zeros to a water activity level.
